(19) United States
(12) Patent Application Publication
(10) Pub. No.: US 2025/0350922 A1
(43) Pub. Date: Nov. 13, 2025

(54) METHOD AND APPARATUS FOR HANDLING MESSAGE SERVICE IN WIRELESS NETWORK

(71) Applicant: SAMSUNG ELECTRONICS CO., LTD., Suwon-si (KR)

(72) Inventors: Sapan Pramodkumar SHAH, Bengaluru (IN); Basavaraj Jayawant PATTAN, Bengaluru (IN)

(21) Appl. No.: 19/201,609

(22) Filed: May 7, 2025

(30) Foreign Application Priority Data
May 9, 2024 (IN) 202441036861
Mar. 4, 2025 (IN) 202441036861

(51) Int. Cl. H04W 8/18; H04W 12/06; H04W 60/00

(52) U.S. Cl. CPC H04W 8/183; H04W 12/06; H04W 60/00

(57) ABSTRACT

The disclosure relates to a 5G or 6G communication system for supporting higher data rates. The disclosure provides a method performed by server. The method includes receiving, from a terminal, a request message to update a stored MSGin5G message originated to a recipient terminal, wherein the request message includes information on an ID of a message which requires update; determining whether the message is stored based on the received ID; in case that the message is stored, performing an update procedure for the stored MSGin5G message, wherein the update procedure includes an update of a store and forward parameter associated with the stored MSGin5G message or a discard of the stored MSGin5G message; and transmitting, to the terminal a response message including information related to a result of the update procedure.

### CROSS-REFERENCE TO RELATED APPLICATIONS

This application is based on and claims priority under 35 U.S.C. § 119 to Indian Provisional Patent Application No. 202441036861 filed on May 9, 2024, and Indian Non-Provisional Patent Application No. 202441036861 filed on Mar. 4, 2025, in the Indian Intellectual Property Office, the disclosure of which are incorporated by reference herein in their entirety.

### BACKGROUND

### 1. Field

The disclosure relates to operations of a terminal and a server in a wireless communication system. In particular, the disclosure relates to a method and an apparatus for a handling a stored message service in the wireless network.

### 2. Description of Related Art

To meet an increasing demand for wireless data communication services since the deployment of the fourth generation (4G) communication system, efforts have been made to develop an improved fifth generation (5G) or pre-5G communication system, referred to as a beyond 4G network or post long term evolution (LTE) system.

5G mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmwave) bands including 28 GHz and 39 GHz bands. In addition, it has been considered to implement 6G mobile communication technologies (referred to as beyond 5G systems) in terahertz bands (e.g.,, 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmwave, supporting numerologies (e.g.,, operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul IAB) for providing a node for network service area expansion by supporting a wireless backhaul link and an access link in an integrated manner, mobility enhancement including conditional handover and dual active protocol stack (DAPS) handover, and two-step random access channel for NR (2-step RACH for NR) to simplify random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The 3^{rd} generation partnership project (3GPP) has defined a messaging service called message service in fifth generation (MSGin5G) for a fifth generation (5G) network. The MSGin5G Service provides messaging communication capability in a fifth generation service (5GS) especially for massive internet of things (MIoT). One of the features of the MSGin5G service is that the MSGin5G service supports “store and forward of messages” feature based on a sender request and availability and reachability of a terminating user equipment (UE) (or recipient UE) which can receive the messages. In this feature, an MSGin5G server (for example) uses a registration and de-registration information of the terminating UE to determine if the terminating (or recipient) UE is available for the message delivery. If the terminating UE is unavailable for the message delivery, the MSGin5G server will store the message and deliver the message once the recipient UE becomes available again.

It is possible that a sender UE and the terminating UE(s) using the MSGin5G services are connected using satellite access type. The 3GPP defined core network (CN) supports a store and forward (S&F) satellite operation mode. The S&F satellite operation mode provides communication service (in storing and forwarding information) to the terminating UE(s), during periods of time in which and/or geographical areas where, a serving satellite is not simultaneously connected to a ground network via a feeder link or inter-satellite links (ISL). During the S&F satellite operation, an application function (AF) entity may receive the S&F event information from the core network (CN) which can be used by the AF entity to enhance an application specific store and forward mechanism.

Although, the MSGin5G service supports store and forward functionality, but it is very basic. The MSGin5G service (including a client and a server) can use the events exposed by the CN to manage the stored messages.

There are use cases where the message is important to deliver to a recipient UE. If the recipient UE is expected to be available after a message expires, then the server will discard the message and the message will not be delivered to the recipient UE. The MSGin5G service do not support a mechanism to update the store and forward parameters (such as message expiry time, etc.) per message by a message originator (e.g., sender UE).

Further, there can be cases where the message originator decides to discard the message which is stored as the message is no more important or based on an expected time of the recipient UE, the message is no more important to be delivered to the recipient UE. There is no mechanism to inform the server to discard the stored message as the user is no more interested in delivering a message to the recipient UE.

Hence, there is a need in the art for solutions which will overcome the above mentioned drawbacks, among others.

### SUMMARY

The disclosure relates to operations of a terminal and a server in a wireless communication system. In particular, the disclosure relates to a method and an apparatus for managing (or updating) a stored message in a messaging service in the wireless network.

Accordingly, an aspect of the disclosure is to update a store and forward parameter(s) (such as message expiry time and so on) in relation to a stored message, at the server, from a client (or terminal).

Furthermore, another aspect of the disclosure is to provide a method and an apparatus regarding the client that informs the server to discard the stored message, based on intent of the client.

In addition, another aspect of the disclosure is to provide a method and an apparatus of the server that transmits, to a client, a response including a failure cause in relation to updating the store and forward parameter(s), when at least one of the client is an unauthorized client and the stored message does not exist at the server.

Other aspects of the disclosure are to disclose that the server subscribes to a core network to receive a store and forward (S&F) event for a recipient UE/user and to disclose that the server notifies a message originator client/UE about an expected delivery time of the message to the recipient UE/user.

Additional aspects will be set forth in part in the description which follows and, in part, will be apparent from the description, or may be learned by practice of the presented embodiments.

Aspects of the disclosure are to address at least the above-mentioned problems and/or disadvantages and to provide at least the advantages described below.

According to an aspect of an embodiment of the disclosure, a method performed by a server in a wireless communication system is provided. The method includes receiving, from a terminal, a request message to update a stored message service in fifth generation (MSGin5G) message originated to a recipient terminal, wherein the request message includes information on an identifier (ID) of a message which requires update; determining whether the message is stored based on the received ID; in case that the message is stored, performing an update procedure for the stored MSGin5G message, wherein the update procedure includes an update of a store and forward parameter associated with the stored MSGin5G message or a discard of the stored MSGin5G message; and transmitting, to the terminal a response message including information related to a result of the update procedure.

According an aspect of an embodiment of the disclosure, a method performed by a terminal in a wireless communication system. The method includes determining whether to update a message service in fifth generation (MSGin5G) message originated to a recipient terminal, wherein the MSGin5G message is transmitted to a server; transmitting, to the server, a request message to update the MSGin5G message including information on an identifier (ID) of a message which requires update; and receiving, from the server, a response message including information related to a result of an update procedure for the MSGin5G message, wherein the update procedure includes an update of a store and forward parameter associated with the MSGin5G message or a discard of the MSGin5G message.

According to an aspect of an embodiment of the disclosure, a server in a wireless communication system is provided. The server includes a transceiver; and a processor coupled to the transceiver and configured to: receive, from a terminal, a request message to update a stored message service in fifth generation (MSGin5G) message originated to a recipient terminal, wherein the request message includes information on an identifier (ID) of a message which requires update, determine whether the message is stored based on the received ID; in case that the message is stored, perform an update procedure for the stored MSGin5G message, wherein the update procedure includes an update of a store and forward parameter associated with the stored MSGin5G message or a discard of the stored MSGin5G message, and transmit, to the terminal, a response message including information related to a result of the update procedure.

According to an aspect of an embodiment of the disclosure, a terminal in a wireless communication system is provided. The terminal includes a transceiver; and a processor coupled to the transceiver and configured to: determine whether to update a message service in fifth generation (MSGin5G) message originated to a recipient terminal, wherein the MSGin5G message is transmitted to a server, transmit, to the server, a request message to update the MSGin5G message including information on an identifier (ID) of a message which requires update, and receive, from the server, a response message including information related to a result of an update procedure for the MSGin5G message, wherein the update procedure includes an update of the store and forward parameter associated with the MSGin5G message or a discard of the MSGin5G message.

Accordingly, the embodiments herein provide a method to manage a stored message during a messaging service (e.g., 5G messaging service or the like) in a wireless network. The method comprises receiving, by a server, a request message to update a stored message from a client, wherein the request message comprises a message identifier (ID) and an information element (IE). Further, the method comprises determining, by the server, that the message is stored based on the received message ID. The method further comprises determining, by the server, whether the IE associated with the message is present in the request message. Further, the method comprises performing, by the server, one of: updating a store and forward parameter(s) associated with the stored message in response determining that the IE associated with the message is present in the request message, and discarding the stored message in response determining that the IE associated with the message is not present in the request message.

Accordingly, embodiments herein disclose a method for handling a message service in a wireless network. The method comprises sending, by a client, a request message to update a stored message to a server, where the request message includes a message identifier (ID) and an information element (IE). In an embodiment, the method further comprises receiving, by the client, a response about updating a store and forward parameter(s) associated with the stored message in response determining that the IE associated with the message is present in the request message at the server, where the server determines that the message is stored based on the received message ID. In another embodiment, the method comprises receiving, by the client, a response about discarding the stored message in response determining that the IE associated with the message is not present in the request message at the server, where the server determines that the message is stored based on the received message ID.

Accordingly, embodiments herein disclose a server including a message handling controller coupled with a processor and a memory. The message handling controller is configured to receive a request message to update a stored message from a client, where the request message includes a message identifier (ID) and an IE. Further, the message handling controller is configured to determine that the message is stored based on the received message ID. Further, the message handling controller is configured to determine whether the IE associated with the message is present in the request message. Further, the message handling controller is configured to perform one of: update a store and forward parameter(s) associated with the stored message in response determining that the IE associated with the message is present in the request message, and discard the stored message in response determining that the IE associated with the message is not present in the request message.

Accordingly, embodiments herein disclose, a client including a message handling controller coupled with a processor and a memory. The message handling controller is configured to send a request message to update a stored message to a server, where the request message includes a message identifier (ID) and an IE. Further, the message handling controller is configured to receive a response about updating a store and forward parameter(s) associated with the stored message in response determining that the IE associated with the message is present in the request message at the server, where the server determines that the message is stored based on the received message ID. In another embodiment, the message handling controller is configured to receive a response about discarding the stored message in response determining that the IE associated with the message is not present in the request message at the server, where the server determines that the message is stored based on the received message ID.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

According to an embodiment of the disclosure, the message originator is capable of dynamically changing the configuration of MSGin5G message stored at the server, by indicating the update of the MSGin5G message.

Furthermore, according to an embodiment of the disclosure, by allowing a message originator to update store and forward parameters (e.g., message expiry time), the important messages will be delivered to the recipient terminal even when the terminal becomes available after the initially defined expiry time.

In addition, according to an embodiment of the disclosure, the message originator may indicate a discard of the MSGin5G message stored in the server when it is no longer necessary, for preventing unnecessary message delivery attempts.

The effects obtainable in the disclosure are not limited to the above-mentioned effects, and other effects not mentioned herein will be clearly understood from the following description by those skilled in the art to which the disclosure belongs.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the following illustrated drawings.

The above and other aspects, features, and advantages of certain embodiments of the disclosure will be more apparent from the following description taken in conjunction with the accompanying drawings, in which:

FIG. 1A illustrates a wireless network to manage a stored message in a messaging service according to embodiments as disclosed herein;

FIG. 1B illustrates hardware components of a server according to the embodiments as disclosed herein;

FIG. 1C illustrates various hardware components of a client according to the embodiments as disclosed herein;

FIG. 2A illustrates a method of a server for handling the messaging service in the wireless network according to embodiments as disclosed herein;

FIG. 2B illustrates a method of a server for handling the messaging service in the wireless network according to embodiments as disclosed herein;

FIG. 3 illustrates a method of a client for handling the messaging service in the wireless network according to embodiments as disclosed herein;

FIG. 4 illustrates a sequence diagram of the method to manage the stored message in the messaging service in the wireless network according to embodiments as disclosed herein; and

FIG. 5 is an example sequence diagram of a method for updating and discarding the stored message in an MSGin5G messaging service according to embodiments as disclosed herein.

### DETAILED DESCRIPTION

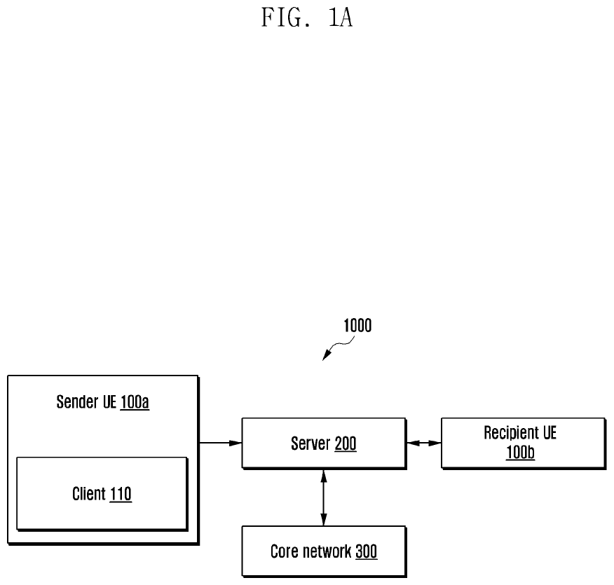

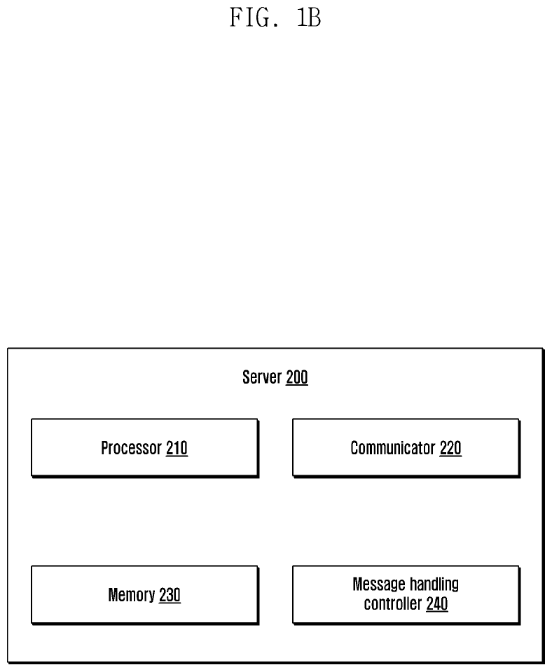

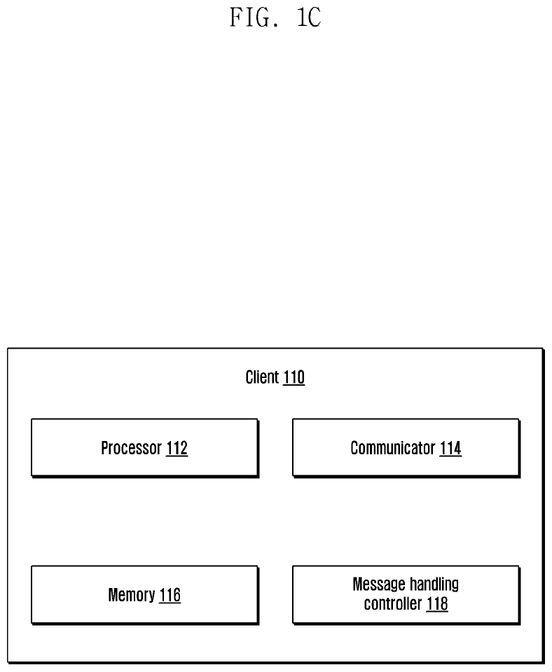

FIG. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Those of ordinary skill in the art will recognize that various changes and modifications of the various embodiments described herein can be made without departing from the scope and spirit of the disclosure. In addition, descriptions of well-known functions and constructions may be omitted for clarity and conciseness.

In order to make the objectives, technical schemes and advantages of the embodiments of the disclosure, a clear and complete description will be made with respect to the technical schemes of the embodiments of the disclosure, in conjunction with the accompanying drawings of the embodiments of the disclosure. Apparently, the described embodiments are a part of the embodiments of the disclosure, not all of the embodiments. Based on the described embodiments of the disclosure, all other embodiments obtained by common skilled in the art without creative labor belong to the protection scope of the disclosure.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be necessary. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Furthermore, the expressions “if” and “in case that” as used in the present specification or claims may, depending on the context, be interpreted to mean “when,” “in response to,” “based on,” or “according to,” and such expressions may be used interchangeably. In addition, other expressions having substantially the same meaning may also be used in place of these expressions, as long as the technical features of the present disclosure are not impaired. Furthermore, the term “configured” to indicate that predetermined information is set by a base station or a network may imply that the predetermined information is received via a predetermined message (for example, an RRC message).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As described above, it should be noted that each block of the flowcharts and combinations of the flowcharts described in the disclosure may be performed by one or more computer programs including instructions. The entirety of the one or more computer programs may be stored in a single memory device, or the one or more computer programs may be stored in a plurality of memory devices in a distributed manner.

In addition, the functions or operations described in the disclosure may be processed by a single processor or a combination of processors. The single processor or the combination of processors may be a circuit that performs processing and may include an application processor (AP, e.g., a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near-field communication (NFC) chip, a connectivity chip, a sensor controller, a touch controller, a fingerprint sensor controller, a display driver integrated circuit (IC), an audio codec (CODEC) chip, a universal serial bus (USB) controller, a camera controller, an image processing IC, a microprocessor unit (MPU), a system on chip (SoC), an IC, or a similar circuit.

Furthermore, it should be noted that various embodiments in the claims and descriptions of the disclosure may be implemented in the form of hardware, software, or a combination of hardware and software. Such software may be stored in a non-transitory computer-readable storage medium. The non-transitory computer-readable storage medium stores one or more computer programs (software modules), and the one or more computer programs include computer-executable instructions which, when executed individually or collectively by one or more processors of an electronic device, operate the electronic device to perform the method according to the disclosure.

The software may be stored in a transient or non-transitory storage device, for example, in the form of read-only memory (ROM) (regardless of whether it is erasable or rewritable), or random access memory (RAM), memory chips, devices, or integrated circuits (ICs). Also, the software may be stored in optically or magnetically readable media such as compact discs (CDs), digital versatile discs (DVDs), magnetic disks, or magnetic tapes. It should be understood that the storage devices and storage media are examples of non-transitory machine-readable storage media suitable for storing a program for implementing various embodiments of the disclosure.

Accordingly, various embodiments provide a program including code for implementing a device or method according to any one of the claims of the disclosure, and a non-transitory machine-readable storage medium storing such a program.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,”, “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve a system and a method to manage stored messages in a 5G messaging service. The provided method can be used to enable the user to update a parameter for the stored message or the discard the message, which may enable sending the MSGin5G message to the recipient receiver when the recipient receiver is expected to be available after expiration time, which may improve the end user experience and service satisfaction.

Referring now to the drawings, and more particularly through FIGS. 1 to 5, where similar reference characters denote corresponding features consistently throughout the figures, there are shown at least one embodiment.

FIG. 1A illustrates a wireless network (1000) to manage a stored message in a messaging service according to embodiments as disclosed herein. In an example embodiment herein, the wireless network (1000) can comprise, a sender UE (100a), a server (200), a recipient UE (100b) and a core network (300) (e.g., Network Exposure Function (NEF) entity). In an embodiment herein, the sender UE (100a) can comprise a client (110). The server (200) communicates with the sender UE (100a) and the recipient UE (100b). Further, in an embodiment herein, the recipient UE (100b) can comprise a communication module (not shown) to communicate with the server (200).

In an example embodiment herein, the sender UE (100a) and the recipient UE (100b) can be a portable mobile device or an unmovable mobile device. Further, the sender UE (100a) and the recipient UE (104) can be an electronic equipment with communication facility designed to serve as a medium for facilitating virtual interaction with the wireless network (1000). Further, the sender UE (100a) and the recipient UE (100b) can be such as a portable computer, a computing device, a laptop, a smart phone, a desktop computer, a notebook, a device-to-device (D2D) device, a vehicle to everything (V2X) device, a foldable phone, a smart TV, a tablet, an immersive device, and an internet of things (IoT) device, etc., wherein the sender UE (100a) can be authorized for updating “store and forward” parameters information element (IE) related to transmission of stored messages at the sever (200).

The client (110) sends a message to the server (200). The server (200) receives the message from the client (110), where the message includes a notification target uniform resource identifier (URI). Based on a registration information of the recipient UE (100b), the server (200) determines to store the message. Further, the server (200) subscribes to receive a store and forward (S&F) event from the core network (300) using an event exposure subscribe technique. The S&F event provides details of the recipient UE (100b). Further, the server (200) sends a first response message to the client (110). The first response message indicates that the message is stored at the server (200).

Further, the server (200) receives the S&F event from the core network (300). The S&F event indicates an availability of an event detail. Further, the server (200) sends a second response message to the client (110). The second response message includes a message identifier (ID), a recipient UE identity, and an expected delivery time to deliver the message to the recipient UE (100b).

In an embodiment, the client (110) sends a request message to update the stored message to the server (200). The request message includes at least one of: a message identifier (ID) and an information element. The information element can be, for example, but not limited to a store and forward parameter IE. Further, the server (200) receives the request message to update the stored message from the client (110). Further, the server (200) determines that the message is stored based on the received message ID. Further, the server (200) determines whether the IE associated with the message is present in the request message. In an embodiment, in response to determining that the IE associated with the message is present in the request message, the server (200) updates the store and forward parameter(s) associated with the stored message. In another embodiment, in response to determining that the IE associated with the message is not present in the request message, the server (200) discards the stored message. The store and forward parameter(s) comprises a message expiration time. The information element includes a store and forward parameter IE.

The server (200) sends a response message to update the stored message to the client (110), wherein the response message comprises a failure cause, when at least one of: the client (110) is not authorized to update the store and forward parameter(s) and the message does not exist at the server (200).

FIG. 1B illustrates various hardware components of the server (200) according to the embodiments as disclosed herein. In an embodiment, the server (200) includes a processor (210, or one or more processors), a communicator (or a transceiver) (220), a memory (230) and a message handling controller (240). The processor (210) is coupled with the communicator (or a transceiver) (220), the memory (230) and the message handling controller (240). Alternatively, a message handling controller (240) may be included in the processor (210).

The message handling controller (240) receives the message from the client (110), where the message includes the notification target URI. Based on the registration information of the recipient UE (100b), the message handling controller (240) (200) determines to store the message. Further, the message handling controller (240) subscribes to receive a store & forward (S&F) event from the core network (300) using the event exposure subscribe technique. The S&F event provides details of the recipient UE (100b). Further, the message handling controller (240) sends a first response message to the client (110). The first response message indicates that the message is stored at the server (200).

Further, the message handling controller (240) receives the S&F event from the core network (300). The S&F event indicates an availability of an event detail. Further, the message handling controller (240) sends a second response message to the client (110). The second response message includes the message identifier (ID), the recipient UE identity, and the expected delivery time to deliver the message to the recipient UE (100b).

Further, the message handling controller (240) receives the request message to update the stored message from the client (110). The request message includes the message ID and the IE. Further, the message handling controller (240) determines that the message is stored based on the received message ID. Further, the message handling controller (240) determines whether the IE associated with the message is present in the request message. In an embodiment, in response to determining that the IE associated with the message is present in the request message, the message handling controller (240) updates the store and forward parameter(s) associated with the stored message. In another embodiment, in response to determining that the IE associated with the message is not present in the request message, the message handling controller (240) discards the stored message. The store and forward parameter(s) comprises the message expiration time.

The message handling controller (240) sends the response message to update the stored message to the client (110), wherein the response message comprises a failure cause, when at least one of: the client (110) is not authorized to update the store and forward parameter(s) and the message does not exist at the server (200).

The message handling controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (210) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (210) may include multiple cores and is configured to execute the instructions stored in the memory (230).

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in random access memory (RAM) or cache).

In an example embodiment, the communicator (220) can include an electronic circuit specific to a standard that enables wired or wireless communication. In an example embodiment herein, the communicator (220) may include, for example, at least one of an Internet, a wired medium (e.g., a local area network (LAN), a controller area network (CAN) network, a universal asynchronous receiver/transmitter (UART), a bus network, Ethernet and so on), a wireless medium (a Wi-Fi network, a cellular network, a Wi-Fi hotspot, Bluetooth, Zigbee and so on using wireless application protocol), a direct interconnection, and so on.

Although the FIG. illustrates hardware components of the server (200) but it is to be understood that other embodiments are not limited thereon. In other embodiments, the server (200) may include less or a greater number of components. Further, the labels or names of the components are used only for illustrative purposes and does not limit the scope of the present disclosure. One or more components can be combined together to perform same or substantially similar function in the server (200).

FIG. 1C illustrates various hardware components of the client (110), according to the embodiments as disclosed herein. In an embodiment, the client (110) includes a processor (112, or one or more processor), a communicator (or a transceiver) (114), a memory (116) and a message handling controller (118). The processor (112) is coupled with the communicator (114), the memory (116) and the message handling controller (118). Alternatively, the message handling controller (118) may be included in the processor (112).

The message handling controller (118) sends the message to the server (200). The message includes the notification target URI. Further, the message handling controller (118) receives the first response message from the server (200). The first response message indicates that the message is stored at the server (200), when the server (200) subscribes to receive the S&F event from the core network (300) using the event exposure subscribe technique. The S&F event provides the details of the recipient UE (100b). Further, the message handling controller (118) receives the second response message from the server (200), where the second response message includes the message ID, the recipient UE identity, and the expected delivery time to deliver the message to the recipient UE (100b), when the server (200) receives the S&F event from the core network (300). The S&F event indicates an availability of the event in detail. Further, the message handling controller (118) sends the request message to update stored message to the server (200). The request message includes the message ID and the IE.

In an embodiment, the message handling controller (118) receives the response message about updating the store and forward parameter(s) associated with the stored message in response to determining that the IE associated with the message is present in the request message at the server (200), where the server (200) determines that the message is stored based on the received message ID.

In another embodiment, the message handling controller (118) receives the response message about discarding the stored message in response to determining that the IE associated with the message is not present in the request message at the server (200), where the server (200) determines that the message is stored based on the received message ID.

The message handling controller (118) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (112) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (112) may include multiple cores and is configured to execute the instructions stored in the memory (116).

Further, the processor (112) is configured to execute instructions stored in the memory (116) and to perform various processes. The communicator (114) is configured for communicating internally between internal hardware components and with external devices via one or more networks. The memory (116) also stores instructions to be executed by the processor (112). The memory (116) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (116) may, in some examples, be considered a non-transitory storage medium. The term “non-transitory” may indicate that the storage medium is not embodied in a carrier wave or a propagated signal. However, the term “non-transitory” should not be interpreted that the memory (116) is non-movable. In certain examples, a non-transitory storage medium may store data that can, over time, change (e.g., in random access memory (RAM) or cache).

In an example embodiment, the communicator (114) can include an electronic circuit specific to a standard that enables wired or wireless communication. In an example embodiment herein, the communicator (114) may include, for example, at least one of an Internet, a wired medium (e.g., a local area network (LAN), a controller area network (CAN) network, a universal asynchronous receiver/transmitter (UART), a bus network, Ethernet and so on), a wireless medium (a Wi-Fi network, a cellular network, a Wi-Fi hotspot, Bluetooth, Zigbee and so on using wireless application protocol), a direct interconnection, and so on.

Although the FIG. 1C illustrates various hardware components of the client (110) but it is to be understood that other embodiments are not limited thereon. In other embodiments, the client (110) may include less or a greater number of components. Further, the labels or names of the components are used only for illustrative purposes and does not limit the scope of the present disclosure. One or more components can be combined together to perform the same or substantially similar function in the client (110).

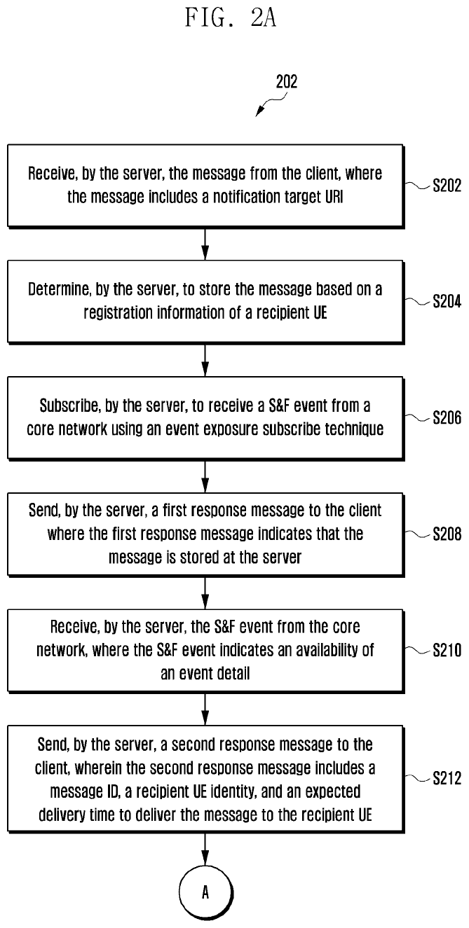

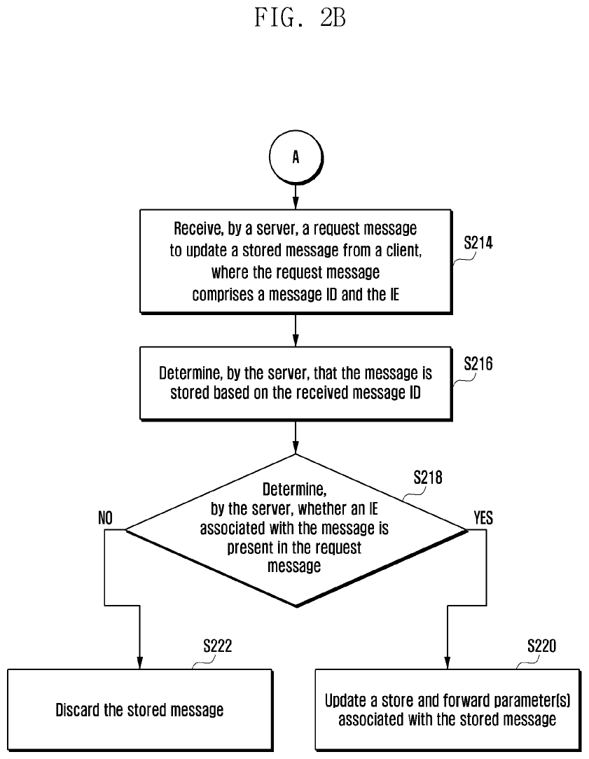

FIG. 2A and FIG. 2B illustrate a method (202), performed by the server (200), for handling the messaging service in the wireless network (1000), according to embodiments as disclosed herein server (200). The operations (S202-S222) are handled by the message handling controller (240).

At S202, the method includes receiving the message from the client (110). The message includes the notification target URI. At S204, the method includes determining to store the message based on the registration information of a recipient UE (100b). At S206, the method includes subscribing to receive the S&F event from the core network (300) using the event exposure subscribe technique. The S&F event provides the details of the recipient UE (100b).

At S208, the method includes sending the first response message to the client (110) where the first response message indicates that the message is stored at the server (200). At S210, the method includes receiving the S&F event from the core network (300), where the S&F event indicates the availability of the event detail. At S212, the method includes sending the second response message to the client (110), where the second response message includes the message ID, the recipient UE identity, and the expected delivery time to deliver the message to the recipient UE (100b). In another embodiment, at S212, the method includes sending the notification message to the client (110), where the notification message includes the message ID, the recipient UE identity, and the expected delivery time to deliver the message to the recipient UE (100b).

At S214, the method includes receiving the request message to update the stored message from the client (110), where the request message includes the message ID and the IE. At S216, the method includes determining that the message is stored based on the received message ID. At S218, the method includes determining whether the IE associated with the message is present in the request message.

In an embodiment, at S220, the method includes updating the store and forward parameter(s) associated with the stored message in response to determining that the IE associated with the message is present in the request message. In another embodiment, at S222, the method includes discarding the stored message in response to determining that the IE associated with the message is not present in the request message.

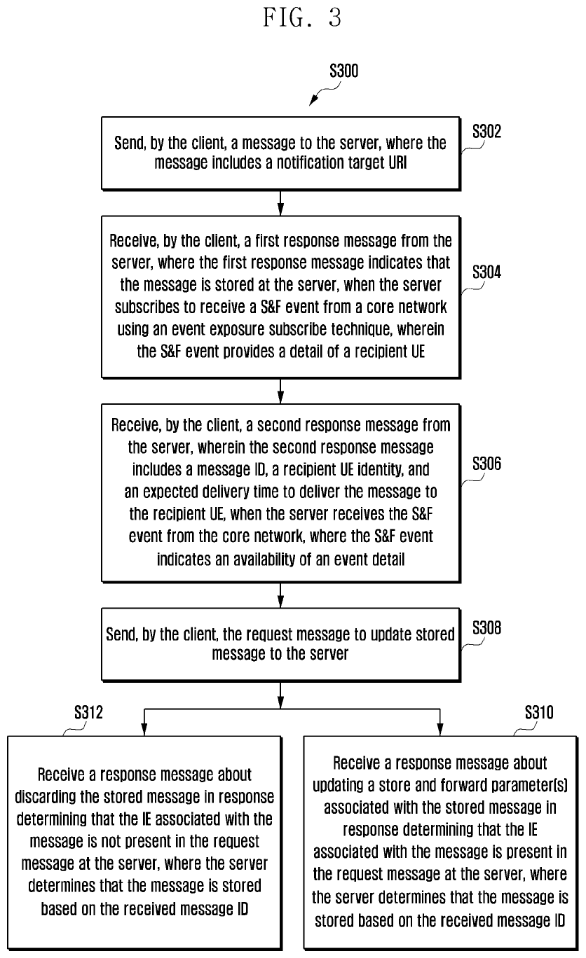

FIG. 3 illustrates a method (S300), performed by the client (110), for handling the messaging service in the wireless network (1000), according to embodiments as disclosed herein. The operations (S302-S312) are handled by the message handling controller (118).

At S302, the method includes sending the message to the server (200). The message includes notification target URI. At S304, the method includes receiving the first response message from the server (200) where the first response message indicates that the message is stored at the server (200), when the server (200) subscribes to receive the S&F event from the core network (300) using the event exposure subscribe technique. The S&F event provides the details of the recipient UE (100b).

At S306, the method includes receiving the second response message from the server (200). The second response message includes the message ID, the recipient UE identity, and the expected delivery time to deliver the message to the recipient UE (100b), when the server (200) receives the S&F event from the core network (300). The S&F event indicates the availability of the event in detail. In another embodiment, at S306, the method includes receiving the notification message from the server (200). The notification message includes the message ID, the recipient UE identity, and the expected delivery time to deliver the message to the recipient UE (100b), when the server (200) receives the S&F event from the core network (300). At S308, the method includes sending the request message to update stored message to the server (200).

In an embodiment, At S310, the method includes receiving the response message about updating the store and forward parameter(s) associated with the stored message in response to determining that the IE associated with the message is present in the request message at the server (200), where the server (200) determines that the message is stored based on the received message ID. In an embodiment, At S312, the method includes receiving the response message about discarding the stored message in response to determining that the IE associated with the message is not present in the request message at the server (200), where the server (200) determines that the message is stored based on the received message ID.

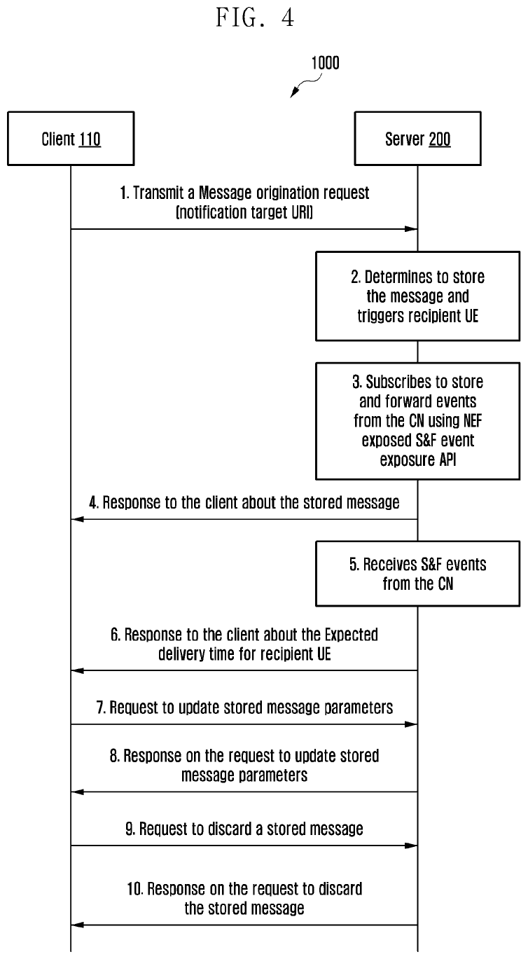

FIG. 4 illustrates a sequence diagram of the method to manage the stored message in the messaging service in the wireless network (1000) according to embodiments as disclosed herein. Below are the steps performed to manage the stored message:

At step 1, the client (110) sends the request for sending the message to the server (200). In an embodiment herein, the request includes identity of the recipient UE (100b), a notification target address, along with other necessary parameter as specified in 3GPP technical specification (TS) 23.554. In an example embodiment herein, as specified in 3GPP TS 23.554, an application client sends a request to an MSGin5G client for invoking an MSGin5G client to send a new MSGin5G message to one or more recipient UEs (100b). Further, the MSGin5G client sends the MSGin5G message request to an MSGin5G server for sending the message to the one or more recipient UEs (100b). As specified in the 3GPP TS 23.554, the message includes the message identifier (ID), a store and forward indication and a “store and forward” parameters IE. In an embodiment herein, the “store and forward” parameter IE can include such as Message expiration time, Application specific store and forward information, and etc. In an embodiment herein, the notification target address is used to receive any intermediate message responses from server (200) to the client (110).

At step 2, the server (200) determines to store the message based on registration information of the recipient UE (100b). In an example embodiment herein, the MSGin5G server may trigger the recipient UE (100b) based on an MSGin5G device triggering procedure as described in 3GPP TS 23.554.

At step 3, the server (200) subscribes with a CN, to receive a plurality of S&F events. In an example embodiment herein, the plurality of S&F events include such as, feeder link availability, expected delivery time, etc. In an embodiment herein, the server (200) subscribes to receive the plurality of S&F events from a network exposure function (NEF) using a Nnef_S&F_EventExposure_Subscribe method and provides recipient UE details to the client (110).

At step 4, the server (200) sends a first response to the client (110), wherein the first response indicates that the message is stored.

At step 5, the core network (i.e., NEF entity or the like) (300) sends the plurality of S&F events to the server (200) when the S&F events details are available, wherein the S&F events details are such as feeder link availability, expected delivery time, etc.

At step 6, the server (102) sends a second response (a notification message or a delivery status) to the client (110). The response includes the message ID, the recipient UE identity, and the expected delivery time to deliver the message to the recipient UE (100b). In an embodiment herein, the client (110) (or user of the sender UE (100a)) considers this information of the second response and decides to update the “store and forward” parameters IE corresponding to the message the client intends to send to the recipient UE (100b). Further, in an embodiment herein, the client (110) (or user of the sender UE (100a)) considers this information of the response and decides to discard the message stored at the server (200).

At step 7, when the client (110) (or user of the sender UE (100a)) decides to update the “store and forward” parameters IE, the client (110) sends a request in relation to update the store and forward parameter(s) to the server (200). In an embodiment herein, the request includes the message ID of the message the client intends to deliver to the recipient UE (100b) and new (updated) “store and forward” parameters IE.

At step 8, upon receiving the request for updating of the store and forward parameter(s), the server (200) determines whether the message is stored based on the received message ID. Upon determining the message is stored, the server (200) updates the “store and forward” parameters IE and sends a response back to the client (110), confirming updating of the IE. In an embodiment herein, when the client (110) is not authorized to update the IE or the message does not exist, then the response transmitted by the server (200) to the client (110), includes a failure cause.

At step 9, if the client (110) decides to discard the stored message at the server (200), the client (110) sends a request to discard the stored message to the server (200). The request includes the message ID.

At step 10, upon receiving the request to discard the stored message, the server (200) checks whether the message is stored based on the received message ID. When the server (200) determines that, the message is stored, the server (200) discards the stored message and sends the response back to the client (110) confirming the discard of the stored message. In an embodiment herein, when the client (110) is not authorized to update the parameter or the message does not exist, then the response from the server (200) includes the failure cause.

In an example embodiment, the client is the MSGin5G client or any service enabler architecture layer (SEAL) service client, or any application enabler client and so on. Further, in an example embodiment, the server is an MSGin5G server or any service enabler architecture layer (SEAL) service server, or any application enabler server and so on.

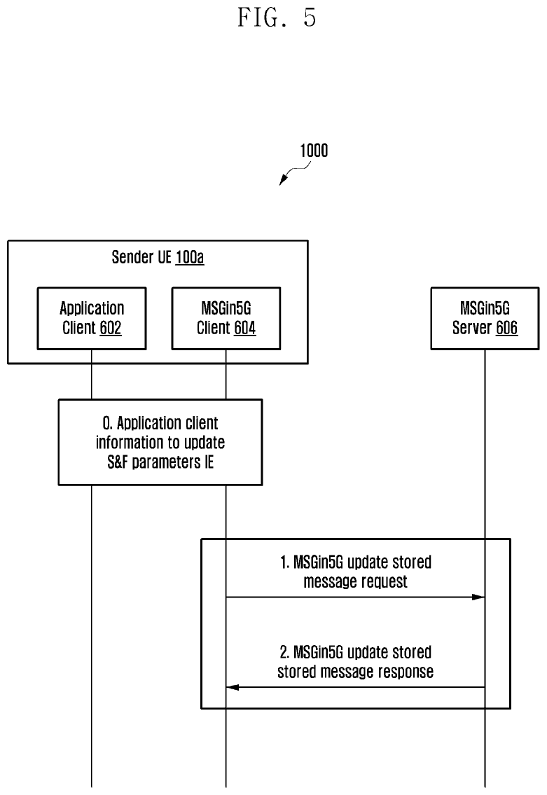

FIG. 5 illustrates an example sequence diagram of a method for updating stored message parameters in an MSGin5G messaging service in the wireless network (1000) according to embodiments as disclosed herein

In an embodiment herein, at step 0, the user or an application client (602) decides to update the stored message. In order to update the stored message, the user or the application client (602) decides to either update store and forward parameters or discard the stored message. The application client (602) informs MSGin5G client (604) to update the stored message.

At step 1, the MSGin5G client (604) sends a request to update the stored message to the MSGin5G Server (606). The message includes the message ID for which “store and forward” parameters IE may be updated, and new or updated “store and forward” parameters IE (e.g., Message expiration time) as specified in Table 1.

Upon receiving the request, if the MSGin5G client is not authorized to update the stored message (e.g., to update store and forward parameters or to discard the message), the MSGin5G Server sends failure response in step-2.

If the MSGin5G client (604) is authorized, the MSGin5G server (606) checks whether the message is stored based on the received message ID. If message is stored, and if “store and forward parameters” IE is present, then the MSGin5G server (604) updates the store and forward parameters. If the “store and forward parameters” IE is not present, the MSGin5G server (604) discards the stored message. The MSGin5G server (604) sends a response back to the MSGin5G client (604). If the message does not exist, then the response message includes the failure cause.

Below table 1 indicates for updating the stored message request (e.g., MSGin5G update stored message request).

TABLE 1

| Information element | Status | Description |
|---|---|---|
| Originating UE Service | (Mandatory) | The service identity of the |
| ID/AS Service ID | M | sending MSGin5G client or |
| | | the sending application server. |
| Destination address | M | The targeted server address |
| Message ID | M | Unique identifier of the stored |
| | | message which requires update |
| | | (i.e., for which parameters may |
| | | be updated or be discarded) |
| Store and forward | (Optional) O | Updated parameters used by |
| parameters | | MSGin5G Server for providing |
| | | store and forward services. |

This IE is only present if the request is to update stored and forward parameters.

Table 2 indicates the update stored message response (e.g., MSGin5G update stored message response or the like).

TABLE 2

| Information | | |
|---|---|---|
| element | Status | Description |
| Result | M | Indication if the procedure is success or failure |
| Failure Cause | O | The reason for failure |

This IE may only be present when the result is Failure.

The provided method can be used to enable the user to update a parameter for the stored message or the discard the message, which may enable sending the MSGin5G message to the recipient receiver when the recipient receiver is expected to be available after expiration time, which may improve the end user experience and service satisfaction.

The various actions in the method (S200-S300) may be performed in the order presented, in a different order or simultaneously. Further, in some embodiments, some actions listed in figures (FIG. 2A-FIG. 3) may be omitted.

Embodiments herein disclose a system and method for handling message service. The MSGin5G Service provides messaging communication capability in 5GS especially for massive internet of things (MIoT). One of the features of the MSGin5G service is that it support store and forward of messages based on the sender request and the availability and reachability of the terminating device. It is possible that the UEs using the MSGin5G services are connected using satellite access type and may be available when feeder link is available to connect. In an example embodiment, the MSGin5G service disclosed herein, can support mechanism to update the store and forward parameter(s) (like message expiry time) per message by the message initiator if user/client wants to ensure the delivery of the message to the recipient. Alternatively, embodiments herein disclose a mechanism to inform server to discard the stored message as the user is no longer interested in delivering message to the recipient UE (100b)/user. The embodiments herein disclose methods to manage the stored message at the server to enable client to update the stored messages or to discard the stored messages.

The embodiments disclosed herein describe the system and method to manage the stored message in the messaging service. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the present disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a server in a wireless communication system, the method comprising:
receiving, from a terminal, a request message to update a stored message service in fifth generation (MSGin5G) message originated to a recipient terminal, wherein the request message includes information on an identifier (ID) of a message which requires update;
determining whether the message is stored based on the received ID;
in case that the message is stored, performing an update procedure for the stored MSGin5G message, wherein the update procedure includes an update of a store and forward parameter associated with the stored MSGin5G message or a discard of the stored MSGin5G message; and
transmitting, to the terminal a response message including information related to a result of the update procedure.

2. The method of claim 1, wherein performing the update procedure further includes:
in case that information on an updated store and forward parameter is present in the request message, updating the store and forward parameter; and
in case that the information on the updated store and forward parameter is not present in the request message, discarding the stored MSGin5G message.

3. The method of claim 1, further comprising:
receiving, from the terminal, a request for sending an MSGin5G including information on the store and forward parameter used for providing a store and forward service; and
storing the MSGin5G message in case that the recipient terminal is not available for a message delivery, the MSGin5G message being the stored MSGin5G message,
wherein the information on the store and forward parameter includes information indicating an expiration time for the stored MSGin5G message,
wherein the stored MSGin5G message is delivered to the recipient terminal when the recipient terminal becomes available,
wherein the request further includes an ID associated with the recipient terminal, and
wherein whether the recipient terminal is available for the message delivery is determined based on a registration status of the recipient terminal.

4. The method of claim 1, wherein, in case that the message does not exist or the terminal is not authorized to update the stored MSGin5G message, the response message further includes a failure cause indicating a reason for failure.

5. A method performed by a terminal in a wireless communication system, the method comprising:
determining whether to update a message service in fifth generation (MSGin5G) message originated to a recipient terminal, wherein the MSGin5G message is transmitted to a server;
transmitting, to the server, a request message to update the MSGin5G message including information on an identifier (ID) of a message which requires update; and
receiving, from the server, a response message including information related to a result of an update procedure for the MSGin5G message, wherein the update procedure includes an update of a store and forward parameter associated with the MSGin5G message or a discard of the MSGin5G message.

6. The method of claim 5, wherein the ID corresponds to the MSGin5G message,
wherein, in case that the request message further includes information on an updated store and forward parameter, the update procedure includes the update of the store and forward parameter, and
wherein, in case that the request message does not include the information on the updated store and forward parameter, the update procedure includes the discard of the MSGin5G message.

7. The method of claim 5, further comprising:
transmitting, to a server, a request for sending the MSGin5G message including information on the store and forward parameter used for providing a store and forward service,
wherein the information on the store and forward parameter includes information indicating an expiration time for the MSGin5G message,
wherein the MSGin5G message is delivered to the recipient terminal when the recipient terminal becomes available,
wherein the request further includes an ID associated with the recipient terminal, and
wherein whether the recipient terminal is available for the message delivery is determined based on a registration status of the recipient terminal.

8. The method of claim 5, wherein in case that the ID does not correspond to the MSGin5G message or the terminal is not authorized to update the MSGin5G message, the response message further includes a failure cause indicating a reason for failure.

9. A server in a wireless communication system, the server comprising:
a transceiver; and
a processor coupled to the transceiver and configured to:
receive, from a terminal, a request message to update a stored message service in fifth generation (MSGin5G) message originated to a recipient terminal, wherein the request message includes information on an identifier (ID) of a message which requires update,
determine whether the message is stored based on the received ID,
in case that the message is stored, perform an update procedure for the stored MSGin5G message, wherein the update procedure includes an update of a store and forward parameter associated with the stored MSGin5G message or a discard of the stored MSGin5G message, and
transmit, to the terminal, a response message including information related to a result of the update procedure.

10. The server of claim 9, wherein the processor is further configured to:
in case that information on an updated store and forward parameter is present in the request message, update the store and forward parameter; and
in case that the information on the updated store and forward parameter is not present in the request message, discard the stored MSGin5G message.

11. The server of claim 9, wherein the processor is further configured to:
receive, from the terminal, a request for sending an MSGin5G message including information on the store and forward parameter used for providing a store and forward service, and
store the MSGin5G message in case that the recipient terminal is not available for a message delivery, the MSGin5G message being the stored MSGin5G message,
wherein the information on the store and forward parameter includes information indicating an expiration time for the stored MSGin5G message,
wherein the stored MSGin5G message is delivered to the recipient terminal when the recipient terminal becomes available,
wherein the request further includes an ID associated with the recipient terminal, and
wherein whether the recipient terminal is available for the message delivery is determined based on a registration status of the recipient terminal.

12. The server of claim 9, wherein, in case that the message does not exist or the terminal is not authorized to update the stored MSGin5G message, the response message further includes a failure cause indicating a reason for failure.

13. A terminal in a wireless communication system, the terminal comprising:
a transceiver; and
a processor coupled to the transceiver and configured to:
determine whether to update a message service in fifth generation (MSGin5G) message originated to a recipient terminal, wherein the MSGin5G message is transmitted to a server,
transmit, to the server, a request message to update the MSGin5G message including information on an identifier (ID) of a message which requires update, and
receive, from the server, a response message including information related to a result of an update procedure for the MSGin5G message, wherein the update procedure includes an update of the store and forward parameter associated with the MSGin5G message or a discard of the MSGin5G message.

14. The terminal of claim 13, wherein the ID corresponds to the MSGin5G message,
wherein, in case that the request message further includes information on an updated store and forward parameter, the update procedure includes the update of the store and forward parameter, and
wherein, in case that the request message does not include the information on the updated store and forward parameter, the update procedure includes the discard of the MSGin5G message.

15. The terminal of claim 13, wherein the processor is further configured to transmit, to a server, a request for sending the MSGin5G message including information on the store and forward parameter used for providing a store and forward service,
wherein the information on the store and forward parameter includes information indicating an expiration time for the MSGin5G message,
wherein the MSGin5G message is delivered to the recipient terminal when the recipient terminal becomes available,
wherein the request further includes an ID associated with the recipient terminal, and
wherein whether the recipient terminal is available for the message delivery is determined based on a registration status of the recipient terminal.

16. The terminal of claim 13, wherein, in case that the ID does not correspond to the MSGin5G message or the terminal is not authorized to update the MSGin5G message, the response message further includes a failure cause indicating a reason for failure.
